(19) United States
(12) Patent Application Publication
(10) Pub. No.: US 2016/0221172 A1
(43) Pub. Date: Aug. 4, 2016

(54) Hand-held Power Tool

(71) Applicant: HILTI AKTIENGESELLSCHAFT, Schaan (LI)

(72) Inventors: Steffen GEIGER, Muenchen (DE); Stefan HAMMERSTINGL, Muenchen (DE); Markus HARTMANN, Mauerstetten (DE); Erwin MANSCHITZ, Germering (DE)

(73) Assignee: Hilti Aktiengesellschaft, Schaan (LI)

(21) Appl. No.: 15/026,190

(22) PCT Filed: Sep. 24, 2014
(86) PCT No.: PCT/EP2014/070294

§ 371 Date: Mar. 30, 2016

(30) Foreign Application Priority Data
Oct. 3, 2013 (EP) 13187206.1

(51) Int. Cl. B25D 11/12; B25D 16/00

(52) U.S. Cl. CPC B25D 11/125; B25D 16/00

(57) ABSTRACT

A hand-held power tool is disclosed. The hand-held power tool has a drive and a pneumatic percussive mechanism. The percussive mechanism has a hammer movable along a working axis, a driving piston bound to the drive by a connecting rod, and a pneumatic chamber that couples a movement of the hammer to the driving piston. The connecting rod is suspended from the driving piston so as to swivel about a swiveling axis. A sealing ring encloses in a plane a lateral surface of the driving piston. The swiveling axis lies in the plane.

This application claims the priority of International Application No. PCT/EP2014/070294, filed Sep. 24, 2014, and European Patent Document No. 13187206.1, filed Oct. 3, 2013, the disclosures of which are expressly incorporated by reference herein.

### BACKGROUND AND SUMMARY OF THE INVENTION

This invention relates to a hand-held power tool, in particular a hammer drill with a pneumatic percussive mechanism.

As known from DE 102008054976 A1, among other prior art publications, the percussive mechanism includes a driving piston. The driving piston is coupled by means of a cross pin and a connecting rod to a cam gear or an equivalent rotary drive system. The cross pin fixes the connecting rod on its eye in the driving piston. The cross pin is inserted through a radial boring in the cylindrical surface of the driving piston. A sealing ring to seal the pneumatic chamber of the percussion mechanism is inserted into the cylindrical surface.

The sealing ring is subject to significant wear and must be replaced as part of servicing. The service intervals are determined by, among other things, the useful life of the sealing ring.

The hand-held power tool according to the invention has a drive system and a pneumatic percussion mechanism. The percussion mechanism contains a beater that moves on a working axis, a driving piston that is connected to the drive system by means of a connecting rod and a pneumatic chamber that couples a movement of the hammer to the driving piston. The connecting rod can swivel around a swiveling axis, preferably with a pin that is suspended in the driving piston. A sealing ring encompasses, in a plane, a cylindrical surface of the driving piston. The swiveling axis lies in the plane defined by the sealing ring. The pin and the sealing ring preferably overlap completely or partly along the working axis or the swiveling axis is located at an offset with respect to the plane in the percussion direction. The plane is perpendicular to the working axis, parallel to the end face of the driving piston and runs through the center of the sealing ring. The location of the swiveling axis and of the driving end of the connecting rod on opposite sides of the sealing ring is favorable for wear.

The driving piston preferably has a cylindrical surface that is completely closed or closed. at least in the vicinity of the pin. In particular, there are no borings in the cylindrical surface.

In one configuration of the invention, the pin is fixed in the driving piston with a turn-lock fastener. With regard to the turn-lock fastener, in particular a bayonet fastener, it has been found to be advantageous to locate the swiveling axis inside the sealing ring.

### BRIEF DESCRIPTION OF THE DRAWINGS

FIG. 1 shows a hammer drill;

FIG. 2 shows a driving piston in longitudinal section in the plane II-II;

FIG. 3 shows the driving piston in cross section in the plane III-III;

FIG. 4 shows the driving piston in longitudinal section in the plane IV-IV;

FIG. 5 shows a driving piston in longitudinal section in the plane V-V;

FIG. 6 shows the driving piston in cross section in the plane VI-VI;

FIG. 7 shows the driving piston in longitudinal section in the plane VII-VII;

FIG. 8 shows the driving piston in longitudinal section in the plane VIII-VIII;

FIG. 9 shows a driving piston in longitudinal section in the plane IX-IX; and

FIG. 10 shows the driving piston in longitudinal section in the plane X-X.

### DETAILED DESCRIPTION OF THE DRAWINGS

Unless indicated otherwise, in the drawings identical elements or elements with identical functions are identified by identical reference numbers.

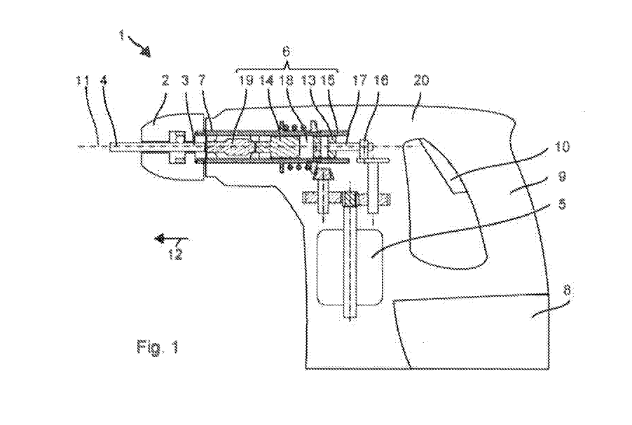

FIG. 1 is a schematic illustration of a hammer drill 1 using the example of a chiseling hand-held. machine tool. The hammer drill 1 has a tool holder 2 into which one shaft end 3 of a tool, e.g., one end of the drill 4, can be inserted. The primary drive system of the hammer drill 1 is formed by a motor 5 that drives a percussion mechanism 6 and an output shaft 7. A battery pack 8 or a power cord supplies the motor 5 with current. A user can guide the hammer drill 1 by means of a hand grip 9 and can initiate the operation of the hammer drill 1 by means of a system switch 10. In operation, the hammer drill 1 rotates the drill 4 continuously around a working axis 11 and the drill 4 can thereby drill into a substrate in the percussion direction 12 along the working axis 11.

The percussion mechanism 6 is a pneumatic percussion mechanism 6. A driving piston 13 and a beater 14 are movably guided in a guide tube 15 in the percussion mechanism 6 along the working axis 11. The driving piston 13 is coupled to the motor 5 by means of a cam 16 and is forced to execute a periodic linear motion. A connecting rod 17 connects the cam 16 with the driving piston 13. A pneumatic spring formed by a pneumatic chamber 18 between the driving piston 13 and the beater 14 couples a movement of the beater 14 to the movement of the driving piston 13. The heater 14 can strike a rear end of the drill 4 directly or indirectly transmit a portion of its pulse to the drill 4 by means of an intermediate beater 19 that is essentially static. The percussion mechanism 6 and preferably the other drive components are located inside a machine housing 20.

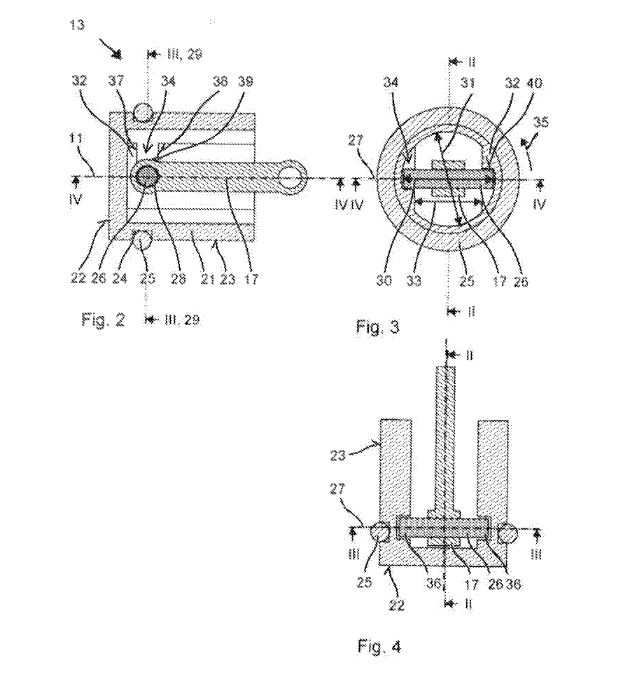

FIG. 2 shows the driving piston 13 in a longitudinal section in the plane II-II; FIG. 3 shows the driving piston 13 in a cross-section in the plane III-III; FIG. 4 is a longitudinal section in the plane IV-IV. The driving piston 13 has a hollow cylindrical base body 21 that is closed on one end surface 22. The end surface 22 faces the heater 14 and compresses and decompresses the pneumatic spring in the pneumatic chamber 18. A cylindrical surface 23 of the base body 21 slides along the inside wall of the guide tube 15. An annular groove 24 is machined into the cylindrical surface 23 near the end surface 22. A sealing ring 25 is inserted into the groove 24. The sealing ring 25 is in contact with the guide tube 15 and provides an airtight seal of the pneumatic chamber 18.

The connecting rod 17 is suspended on a pin 26 in the driving piston 13. The pin 26, which can be cylindrical, for example, defines a swiveling axis 27 around which the connecting rod 17 can swivel. The connecting rod 17 has an eye at 28 into which the pin 26 is inserted. The connecting rod 17 projects essentially radially from the pin 26. The pin 26 is fastened perpendicular to the axis 11. in the driving piston 13.

The swiveling axis 27 of the pin 26 lies in a plane 29 with the sealing ring 25. The swiveling axis 27 therefore runs through the sealing ring 25. The eye 28 of the connecting rod 17 is close to or in the center of gravity of the sealing ring 25.

The offset, along the axis 11, of the swiveling axis 27 from the center of gravity is less than one half the width, measured along the axis 11, of the sealing ring 25. Torques acting between the connecting rod 17 and the sealing ring 25 can thereby be advantageously minimized to enhance the sealing property and the service life of the sealing ring.

The pin 26 lies completely inside the driving piston 13 and the driving piston 13, in the vicinity of the pin 26, has a completely closed cylindrical surface 23. The pin 26 is fastened in the driving piston 13 by a turn-lock fastener, such as a bayonet fastener, for example. The pin 26 can be inserted in an angular orientation into the hollow cylindrical base body 21. A length 30 of the pin 26 is smaller than the radially interior dimension 31 of the base body 21 in this first angular orientation. The base body 21 has a radially projecting web 32 which, in another, second angular orientation, reduces the internal dimension 33 to less than the length 30 of the pin 26. The web 32 is provided at the axial height of the sealing ring 25 with a groove 34 that runs parallel to the circumferential direction 35. The width, i.e., the dimension along the axis 11, of the groove 34 is approximately equal to the diameter of the pin 26. The pin 26 can be rotated into the second angular orientation, wherein its ends 36 projecting beyond the eye 28 are introduced into the groove 34. The flanks 37, 38 of the groove 34 that run perpendicular to the axis 11 chuck the pin 26. The groove 34 can be provided with a barb 39 that prevents the pin 26 from rotating hack into the first angular orientation. Preferably the groove 34 is closed in a peripheral direction 35 by a flank 40 that runs parallel to the axis 11, as a result of which a rotation beyond the second angular orientation is prevented.

During assembly, the connecting rod 17 is first pre-installed with its eye 28 on the pin 26, before the pin 26 is inserted into the driving piston 13 and secured. by rotating it.

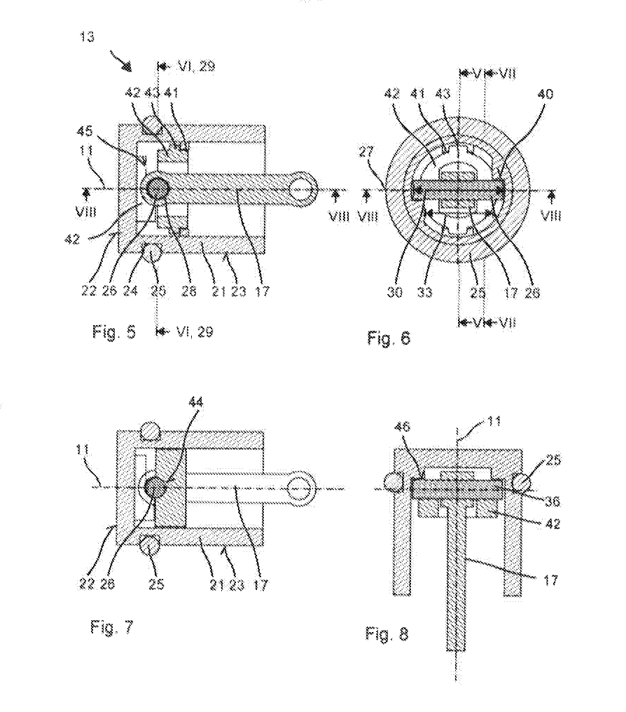

FIGS. 5 to 7 show a variant of the driving piston 13. The driving piston 13 has a hollow cylindrical base body 21 that is closed, on one end surface 22. The sealing ring 25 encompasses the closed cylindrical surface 23 of the base body 21. The cylindrical pin 26 defines the swiveling axis 27 around which the connecting rod 17 is suspended so that it can swivel. The swiveling axis 27 lies in a plane 29 with the sealing ring 25.

The pin 26 is fastened by means of a turn-lock fastener in the driving piston 13. The pin 26 is chucked between the end surface 22 of the driving piston 13 and two radially inward projecting webs 41. A plate 42 bridges the axial distance between the webs 41 in the pin 26. The plate 42 has two radially projecting fingers 43 that are in contact with the two radially inward projecting webs 41 of the base body 21. The plate 42 has a semi-cylindrical recess 44 that is in contact with the pin 26. The pin 26 is also in contact, on an annular flank 45 perpendicular to the axis 11, with the end surface 22. Stops 46 with a flank 40 pointing in the peripheral direction 35 project along the axis 11 from the flank 45.

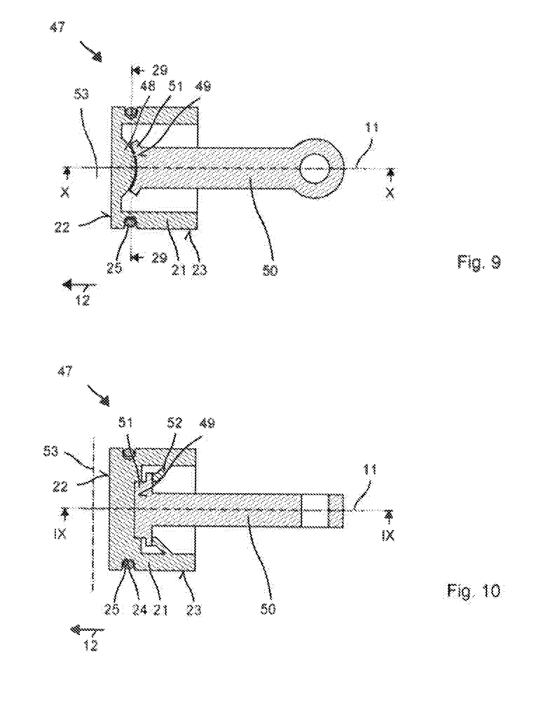

FIGS. 9 and 10 illustrate an additional driving piston 47. The driving piston 47 is connected to a connecting rod 50. The driving piston 47 has a protuberance 48 on its inside opposite the end surface 22. The protuberance 48 has the form of a cylindrical segment. The surface 49 of the protuberance 48 has a. constant radius of curvature. The radius of curvature is preferably greater than the distance of the protuberance from the end surface 22. Accordingly, the axis 53 is offset in the percussion direction 12 outside the driving piston 13. The surface 49 preferably lies inside the sealing ring 25, i.e., the sealing ring 25 and the surface 49 overlap along the working axis 11. The plane 29 defined by the sealing ring 25 preferably intersects the convex surface 49. The connecting rod 50 has one end shaped into a shell 51. The shell 51 has a concave surface, the radius of curvature of which is equal to that of the protuberance 48. The shell 51 lies on the protuberance 48 and by swiveling around the axis 53 can slide along the protuberance 48. The shell 51 transmits thrust forces along the percussion direction 12 into the driving piston 47.

The shell 51 is held in the driving piston 47 by means of a snap connection. The snap connection contains, for example, two or more swiveling tongues 52 that project radially into the interior of the driving piston 13. When the connecting rod 50 is installed, the tongues 52 are in contact against a side of the shell 51 facing opposite to the percussion direction 12.

1-8. (canceled)

9. A hand-held power tool, comprising:
a drive;
a pneumatic percussion mechanism, wherein the pneumatic percussion mechanism includes a beater that is movable on a working axis, a driving piston connected to the drive by a connecting rod, and a pneumatic chamber that couples a movement of the driving piston to the beater, wherein the connecting rod is suspended in the driving piston such that the connecting rod is swivelable around a swiveling axis; and
a sealing ring, wherein the sealing ring, lying in a plane, encompasses a cylindrical surface of the driving piston;
wherein the swiveling axis lies in the plane or wherein the swiveling axis is offset parallel to the plane in a percussion direction.

10. The hand-held power tool according to claim 9, wherein the connecting rod is suspended on a pin in the driving piston and wherein an axis of the pin defines the swiveling axis.

11. The hand-held power tool according to claim 10, wherein the driving piston has a cylindrical surface that is completely closed or at least partly closed in a vicinity of the pin.

12. The hand-held power tool according to claim 10, wherein the pin is fastened in the driving piston by a turn-lock fastener.

13. The hand-held power tool according to claim 10, wherein the pin is disposed in an eye of the connecting rod and wherein the pin is rotatable inside the driving piston between a first angular position and a second angular position.

14. The hand-held power tool according to claim 10, wherein the driving piston has a hollow cylindrical base body with a first radially projecting flank and a second radially projecting flank and wherein an end of the pin is chucked between the first radially projecting flank and the second radially projecting flank.

15. The hand-held power tool according to claim 9, wherein the connecting rod has a shell that is in contact with a cylindrical protuberance in the driving piston.

16. The hand-held power tool according to claim 15, wherein an axis of the cylindrical protuberance defines the swiveling axis and wherein the axis is offset in a percussion direction from the driving piston.
